(19) United States
(12) Patent Application Publication
(10) Pub. No.: US 2014/0126238 A1
(43) Pub. Date: May 8, 2014

(54) LIGHT SOURCE MODULE AND MANUFACTURING METHOD THEREOF

(71) Applicant: WISTRON CORPORATION, New Taipei City (TW)

(72) Inventors: Lien-Te Kao, New Taipei City (TW); Chin-Yung Liu, New Taipei City (TW)

(73) Assignee: WISTRON CORPORATION, New Taipei City (TW)

(21) Appl. No.: 13/789,687

(22) Filed: Mar. 8, 2013

(30) Foreign Application Priority Data
Nov. 7, 2012 (CN) 201210442576.4

(51) Int. Cl. F21V 8/00

(52) U.S. Cl. CPC G02B 6/0023; G02B 6/0065
USPC 362/608; 29/592.1

(57) ABSTRACT

A light source module including a light emitting unit for emitting a light beam, a light guiding plate, and a light coupling unit is provided. The light guiding plate has a first light emitting surface, a first bottom surface, and a first light incident surface, wherein the first light emitting surface is opposite to the first bottom surface, and the first light incident surface connects the first light emitting surface and the first bottom surface. The light coupling unit has a second light incident surface and a second light emitting surface in contact with the first light incident surface. The light emitting unit is disposed beside the second light incident surface. The light beam enters the light coupling unit through the second light incident surface, exits the light coupling unit through the second light emitting surface, and then enters the light guiding plate through the first light incident surface.

### CROSS-REFERENCE TO RELATED APPLICATION

This application claims the priority benefit of China application serial no. 201210442576.4, filed on Nov. 7, 2012. The entirety of the above-mentioned patent application is hereby incorporated by reference herein and made a part of this specification.

### BACKGROUND OF THE DISCLOSURE

1. Field of the Disclosure

The disclosure relates to a light source module and a manufacturing method thereof and more particularly relates to a light source module with a light coupling unit and a manufacturing method thereof.

2. Description of Related Art

The advance of display technology in the past few years contributed to the extensive use of various types of displays, and displays gradually become an indispensable part of our life. For example, light emitting diode displays (LED displays), organic light emitting diode displays (OLEDs), and electrophoretic displays (EPDs) are commonly used as the screens for computers, smart phones, and electronic books. In order to improve display quality and make displays more convenient, displays are developed to be miniaturized and portable.

Because a liquid crystal display panel is a non-self-luminous display, a back light module is required to be used with the display. Generally speaking, the back light module includes components, such as a linear light source, a light guiding plate, an optical film sheet (e.g. diffuser sheet, prism sheet, etc.), and a reflective plate. As the liquid crystal display is miniaturized, the back light module is developed to be thinner, and consequently the thickness of the light guiding plate needs to be reduced. Nevertheless, the prices of light emitting elements, such as LEDs, which are used as the light sources, usually increase as the sizes thereof are reduced. Therefore, the costs for producing thin back light modules are high, which restrains the demand. Considering the production costs and the demand for miniaturization, a light guiding plate that is thicker at the light incident side has been developed in recent years. This type of light guiding plate has a thicker light incident surface to match the light source, which is cheaper and larger in size, and the light emitting part of the light guiding plate remains thin to reduce the size and weight. Generally speaking, this type of light guiding plate may be fabricated by mold injection process. However, it is difficult to fabricate large-sized or ultra-thin light guiding plates with the current technology, and there are many limitations to the application thereof Hence, how to reduce the production costs and at the same time decrease the thickness of the light guiding plate has become an important issue that needs to be solved in this field.

### SUMMARY OF THE DISCLOSURE

The disclosure provides a light source module for improving the light coupling efficiency to a light guiding plate.

The disclosure provides a method for manufacturing a light source module for reducing production costs.

The disclosure provides a light source module, including at least one light emitting unit, a light guiding plate, and at least one light coupling unit. The light emitting unit is adapted for emitting a light beam. The light guiding plate has a first light emitting surface, a first bottom surface, and at least one first light incident surface, wherein the first light emitting surface is opposite to the first bottom surface, and the first light incident surface connects the first light emitting surface and the first bottom surface. The light coupling unit has a second light incident surface and a second light emitting surface. The light emitting unit is disposed beside the second light incident surface. The light beam enters the light coupling unit through the second light incident surface, exits the light coupling unit through the second light emitting surface, and then enters the light guiding plate through the first light incident surface. The first light incident surface is in contact with the second light emitting surface, and the number of the light emitting unit is corresponding to the number of the first light incident surface and the number of the light coupling unit.

In an embodiment of the disclosure, the light coupling unit further includes a second bottom surface and a top surface opposite to the second bottom surface. The second bottom surface and the first bottom surface are located on the same plane. The second bottom surface connects the second light incident surface and the second light emitting surface. The top surface connects the second light incident surface and the second light emitting surface, wherein the length of the second light incident surface in a direction substantially parallel to a normal vector of the second bottom surface is greater than the length of the second light emitting surface in the direction substantially parallel to the normal vector of the second bottom surface.

In an embodiment of the disclosure, the thickness of the light coupling unit gradually decreases from the second light incident surface to the second light emitting surface.

In an embodiment of the disclosure, an included angle between the second light emitting surface and the second bottom surface of the light coupling unit is ψ. The first light incident surface of the light guiding plate and the second light emitting surface of the light coupling unit are substantially parallel to each other, and the included angle ψ satisfies: 110ψ≦ψ≦160.

In an embodiment of the disclosure, the second light emitting surface of the light coupling unit includes a first sub light emitting surface and a second sub light emitting surface. The first sub light emitting surface covers a portion of the first light emitting surface and is substantially parallel to and in contact with the first light emitting surface, and the second sub light emitting surface is substantially parallel to and in contact with the first light incident surface.

In an embodiment of the disclosure, the thickness of the light coupling unit is first maintained and then gradually decreased from the second light incident surface to the second light emitting surface.

In an embodiment of the disclosure, the light coupling unit further includes a plurality of optical micro-structures arranged on the top surface.

In an embodiment of the disclosure, the optical micro-structures include a plurality of V-shaped trenches, wherein a top angle of the V-shaped trenches is less than or substantially equal to 60 degrees, and a depth of the V-shaped trenches is greater than a distance between the top angles of two adjacent V-shaped trenches.

In an embodiment of the disclosure, each of the V-shaped trenches extends in a direction substantially parallel to a juncture of the top surface and the first light emitting surface, and the V-shaped trenches are arranged in a direction substantially perpendicular to the juncture.

In an embodiment of the disclosure, each of the V-shaped trenches extends in the direction substantially perpendicular to the juncture of the top surface and the first light emitting surface, and the V-shaped trenches are arranged in the direction substantially parallel to the juncture.

In an embodiment of the disclosure, the light source module further includes a reflector located under the first bottom surface and the second bottom surface to support the light guiding plate and the light coupling unit.

In an embodiment of the disclosure, the light source module further includes an adhesive layer disposed between the reflector and the light coupling unit and between the reflector and the light guiding plate, such that the light coupling unit and the light guiding plate are fixed to the reflector by the adhesive layer.

In an embodiment of the disclosure, the light source module further includes an outer frame and an adhesive layer. The outer frame receives the light emitting unit, the light coupling unit, a portion of the light guiding plate, and a portion of the reflector. The adhesive layer is disposed between the outer frame and the light coupling unit, wherein the outer frame fixes the light coupling unit and the reflector.

In an embodiment of the disclosure, the light guiding plate and the light coupling unit are bonded to each other through at least one welding point.

In an embodiment of the disclosure, the light source module further includes a reflective layer adhered to a portion of the top surface and a portion of the first light emitting surface.

In an embodiment of the disclosure, the light source module further includes a circuit unit disposed between the outer frame and the light coupling unit and electrically connected to the light emitting unit.

The disclosure provides a method for manufacturing a light source module, and the manufacturing method includes: providing a light guiding plate, which includes a first light emitting surface, a first bottom surface, and at least one first light incident surface, wherein the first light emitting surface is opposite to the first bottom surface, and the first light incident surface connects the first light emitting surface and the first bottom surface. At least one light coupling unit is disposed beside the first light incident surface of the light guiding plate, wherein each light coupling unit includes a second light incident surface and a second light emitting surface, and the second light emitting surface of each light coupling unit is in contact with the first light incident surface of the light guiding plate. Moreover, at least one light emitting unit is disposed beside the second light incident surface, wherein the number of the first light incident surface corresponds to the number of the light coupling unit and the number of the light emitting unit.

In an embodiment of the disclosure, a method for fabricating the light guiding plate includes hot extrusion of resin or hot rolling of resin.

In an embodiment of the disclosure, a method for fabricating the light coupling unit includes mold injection process.

In an embodiment of the disclosure, the manufacturing method of the light source module further includes disposing a reflector at a side of the first bottom surface of the light guiding plate and the second bottom surface of the light coupling unit.

In an embodiment of the disclosure, the manufacturing method of the light source module further includes disposing an adhesive layer between the reflector and the light coupling unit and between the reflector and the light guiding plate to fix the light coupling unit and the light guiding plate to the reflector.

In an embodiment of the disclosure, the manufacturing method of the light source module further includes providing an outer frame to receive the light emitting unit, the light coupling unit, a portion of the light guiding plate, and a portion of the reflector. Then, an adhesive layer is disposed between the outer frame and the light coupling unit for the outer frame to fix the light coupling unit and the reflector.

Based on the above, in the light source module of the embodiments of the disclosure, the light coupling unit is disposed at the light incident surface of the light guiding plate for coupling the light emitted by the light emitting unit to the light guiding plate, so as to improve the light emitting efficiency of the light source module. The manufacturing method of the light source module according to the embodiments of the disclosure is to respectively fabricate the light guiding plate and the light coupling unit, so as to simplify the production procedure, improve production efficiency, and reduce production costs.

To make the aforementioned and other features and advantages of the disclosure more comprehensible, several embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a light source module according to an embodiment of the disclosure.

FIG. 2A is a schematic view illustrating another adhesive layer distribution of the light source module in the embodiment of FIG. 1.

FIG. 2B is a schematic top view illustrating another adhesive layer distribution of the light source module in the embodiment of FIG. 1.

FIG. 3A to FIG. 3F are schematic views illustrating alterations of the light source module in the embodiment of FIG. 1.

FIG. 4A illustrates an optical micro-structure on a second light incident surface of a light coupling unit in the embodiment of FIG. 1.

FIG. 4B illustrates an optical micro-structure on a top surface of the light coupling unit in the embodiment of FIG. 1.

FIG. 4C is an enlarged view of a part of the optical micro-structure in FIG. 4B.

FIG. 4D illustrates an alteration of the optical micro-structure on the top surface of the light coupling unit in the embodiment of FIG. 1.

FIG. 5A is a schematic view of a light source module according to another embodiment of the disclosure.

FIG. 5B is a schematic top view of a light guiding plate in the embodiment of FIG. 5A.

FIG. 6 illustrates a method for manufacturing a light source module according to an embodiment of the disclosure.

### DESCRIPTION OF THE EMBODIMENTS

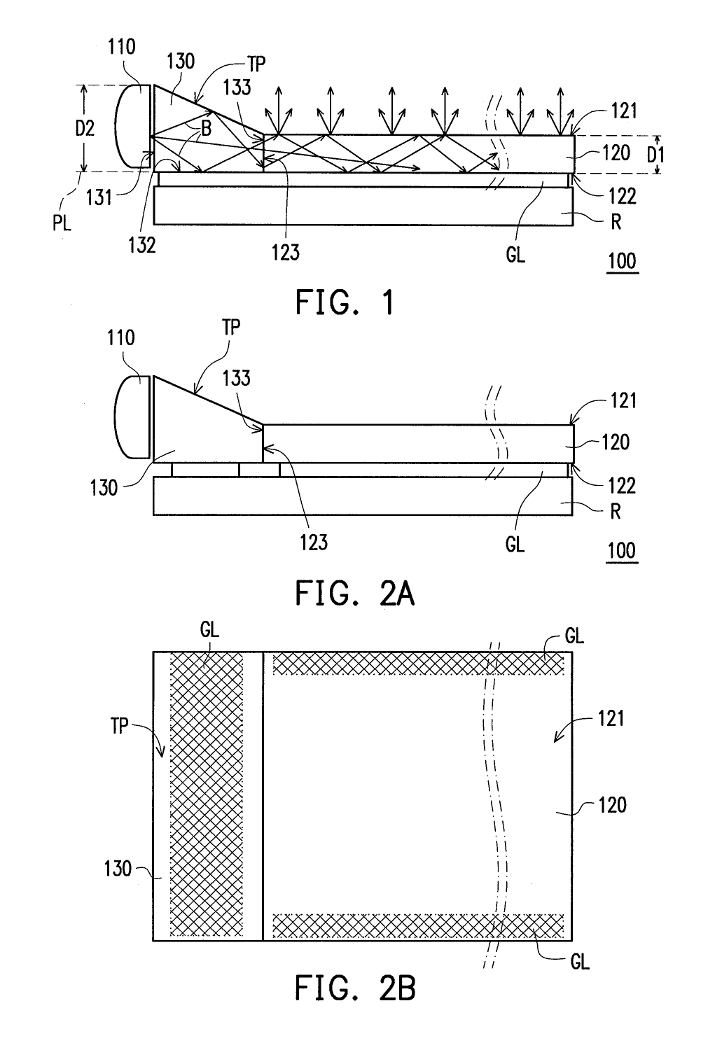

FIG. 1 is a schematic view of a light source module according to an embodiment of the disclosure. With reference to FIG. 1, in this embodiment, a light source module 100 includes at least one light emitting unit 110, a light guiding plate 120, and at least one light coupling unit 130. The light emitting unit 110 is adapted for emitting a light beam B. The light guiding plate 120 has a first light emitting surface 121, a first bottom surface 122, and at least one first light incident surface 123, wherein the first light emitting surface 121 is opposite to the first bottom surface 122, and the first light incident surface 123 connects the first light emitting surface 121 and the first bottom surface 122. The light coupling unit 130 has a second light incident surface 131 and a second light emitting surface 133. The light emitting unit 110 is disposed beside the second light incident surface 131. The light beam B enters the light coupling unit 130 through the second light incident surface 131, exits the light coupling unit 130 through the second light emitting surface 133, and then enters the light guiding plate 120 through the first light incident surface 123. In other words, the light beam B is coupled to the light guiding plate 120 by the light coupling unit 130 and transmitted in the light guiding plate 120, and a portion of the light beam B is refracted by the first light emitting surface 121 and exits the light guiding plate 120. Based on the above, the light source module 100 efficiently couples the light emitted from the light emitting unit 110 to the light guiding plate 120 by means of the light coupling unit 130. Hence, favorable light guiding efficiency is maintained without increasing the thickness of the light guiding plate 120 to match the height of the light emitting unit 110. The light emitting unit 110 is a light source, such as a light emitting diode (LED) or an incandescent lamp, for example. A material of the light guiding plate 120 and the light coupling unit 130 includes an optical level plastic, e.g. Polymethylmethacrylate (PMMA), Polycarbonate (PC), Polystyrene (PS), and Silicone, etc., a vitreous transparent material, or a combination of the foregoing. The light guiding plate 120 and the light coupling unit 130 may be formed of the same or different materials. When the light emitting unit 110 has a greater thickness for the reasons of production costs (production costs rise as the thickness of the light emitting unit 110 decreases) or light emitting efficiency, the light source module 100 can still use the light coupling unit 130 to couple the light to the light guiding plate 120 that is thinner than the light emitting unit 110 and at the same time prevent light leakage caused by the discrepancy between the height of the light emitting unit 110 and the thickness of the light guiding plate 120. It is noted that, in this embodiment, the light guiding plate 120 and the light coupling unit 130 may be separately fabricated. Thus, in the case that a very thin light guiding plate 120 is required, the light guiding plate 120 can still be fabricated to be even and thin by hot extrusion of resin or hot rolling of resin. That is, the problem of unevenness or difficulty of thinning the light guiding plate by mold injection process is avoided.

More specifically, in this embodiment, the first light incident surface 123 is in contact with the second light emitting surface 133, and the number of the light emitting unit 110 is corresponding to the number of the first light incident surface 120 and the number of the light coupling unit 130. In this embodiment, the number of the light emitting unit 110 is one, and the number of the light coupling unit 130 is one as well, for example. The light guiding plate 120 is for example a cuboid, and the light emitting unit 110 and the light coupling unit 130 are disposed beside the first light incident surface 123 of the light guiding plate 120. Nevertheless, in other embodiments, each light coupling unit 130 may correspond to multiple light emitting units 110, and the first light incident surface 123 of each lateral side of the light guiding plate 120 may correspond to multiple light coupling units 130; however, the scope of the disclosure is not restricted thereto.

To be more specific, in this embodiment, the light coupling unit 130 may further include a second bottom surface 132 and a top surface TP opposite to the second bottom surface 132. The second bottom surface 132 and the first bottom surface 122 are located on the same plane PL. The second bottom surface 132 connects the second light incident surface 131 and the second light emitting surface 133. The top surface TP connects the second light incident surface 131 and the second light emitting surface 133. Moreover, the length of the second light incident surface 131 in a direction substantially parallel to a normal vector of the second bottom surface 132 is greater than the length of the second light emitting surface 133 in the direction substantially parallel to the normal vector of the second bottom surface 132. In other words, a thickness D1 at a side of the light coupling unit 130, which is close to the light guiding plate 120, may be less than a thickness D2 at a side of the light coupling unit 130, which is close to the light emitting unit 110. Generally speaking, the light guiding plate 120 with a very thin thickness may be fabricated by hot extrusion of resin or hot rolling of resin. On the other hand, the light coupling unit 130 may be fabricated by mold injection process, extrusion, pressing, or mechanical processing to correspond to the height of the light emitting unit 110 and the thickness of the light guiding plate 120. Therefore, selection of the light emitting unit 110 and the light guiding plate 120 for the light source module 100 becomes more flexible to lower the costs and further to reduce the thickness of the light guiding plate 120 and maintain favorable light guiding effects.

Furthermore, in this embodiment, the light source module 100 may further include a reflector R, which is located under the first bottom surface 122 and the second bottom surface 132 to support the light guiding plate 120 and the light coupling unit 130. Moreover, in this embodiment, the light source module 100 may further include an adhesive layer GL disposed between the reflector R and the light coupling unit 130 and located between the reflector R and the light guiding plate 120. The light coupling unit 130 and the light guiding plate 120 are fixed onto the reflector R by the adhesive layer GL. Specifically, the adhesive layer GL may be a transparent or light-reflective adhesive layer or adhesive tape, but the disclosure is not restricted thereto. By disposing the reflector R, a portion of the light beam B released from the light guiding plate 120 is reflected, so as to direct the light from the light guiding plate 120 toward the first light emitting surface 121 and further to increase the light guiding efficiency and light emitting luminance of the light guiding plate 120. Meanwhile, the light coupling unit 130 and the light guiding plate 120 are fixed by the adhesive layer GL to increase the structural strength of the light source module 100 for more applications.

FIG. 2A is a schematic view illustrating another adhesive layer distribution of the light source module in the embodiment of FIG. 1. FIG. 2B is a schematic top view illustrating another adhesive layer distribution of the light source module in the embodiment of FIG. 1. Referring to FIG. 1, FIG. 2A, and FIG. 2B, the adhesive layer GL of FIG. 1 is spread over the reflector R to fix the light coupling unit 130 and the light guiding plate 120. However, the adhesive layer GL may be selectively distributed on specific areas of the reflector R, as shown in FIG. 2A and FIG. 2B, to save production costs and reduce the weight of the light source module 100 and at the same time achieve favorable optical effects and stable structural strength.

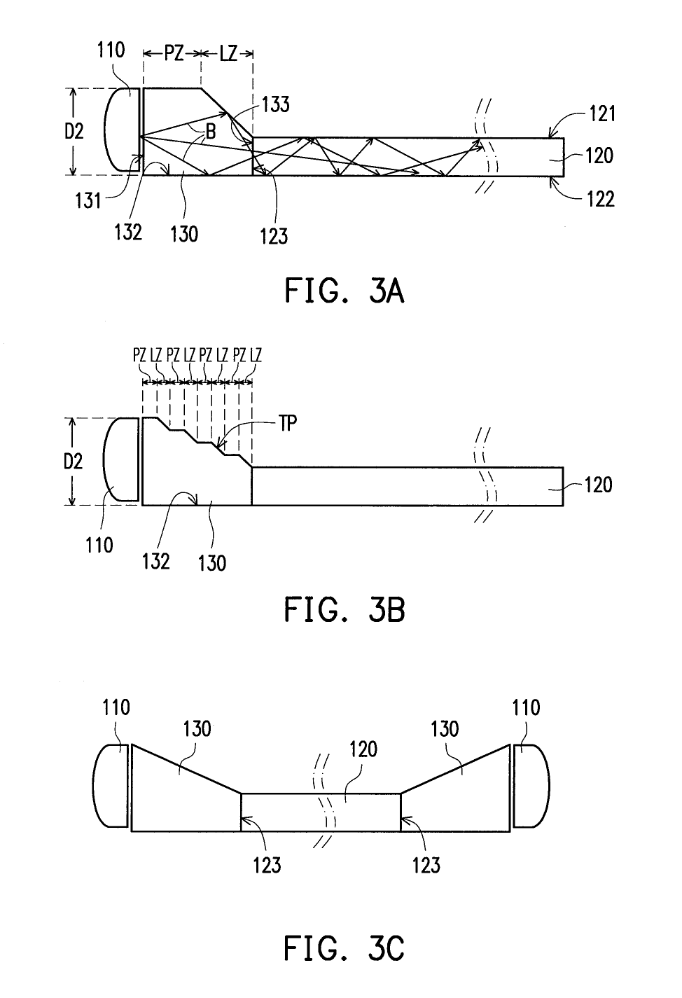

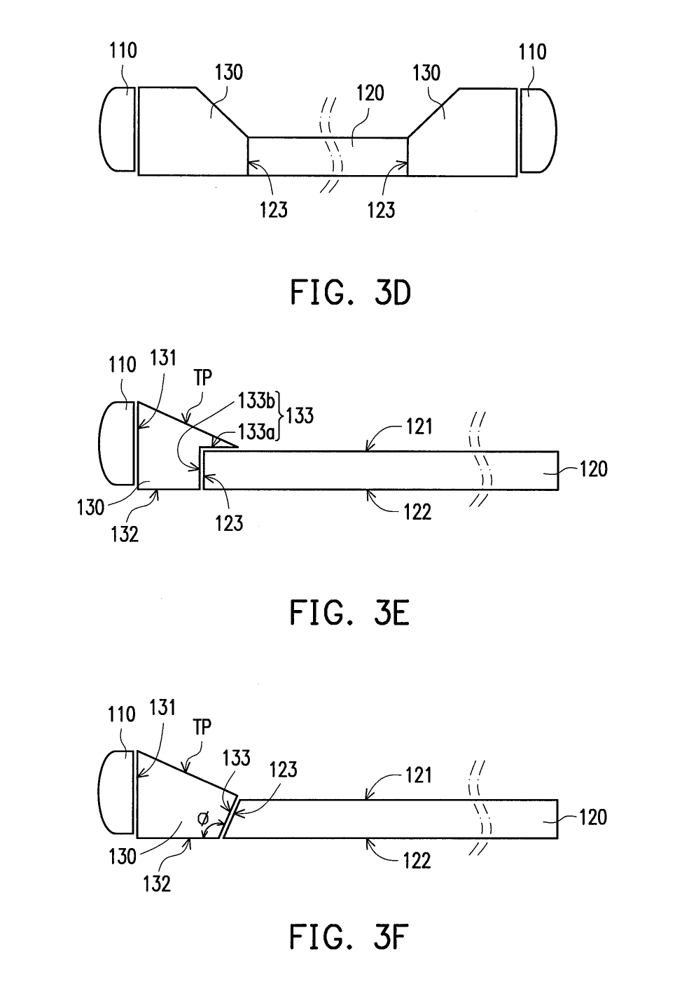

FIG. 3A to FIG. 3F are schematic views illustrating alterations of the light source module in the embodiment of FIG. 1. First, referring to FIG. 1 and FIG. 3A, the thickness D2 of the light coupling unit 130 in the embodiment of FIG. 1 in the direction substantially parallel to the normal vector of the second bottom surface 132 gradually decreases from the second light incident surface 131 to the second light emitting surface 133. However, the light coupling unit 130 may be altered as shown in FIG. 3A and achieve the same efficiency. More specifically, the thickness D2 of the light coupling unit 130 of FIG. 3A in the direction substantially parallel to the normal vector of the second bottom surface 132 is first maintained and then gradually decreased from the second light incident surface 131 to the second light emitting surface 133. In other words, the top surface TP in FIG. 3A has a planar region PZ and an inclined region LZ, and the top surface TP is still capable of reflecting or totally reflecting the light beam B emitted from the light emitting unit 110 and properly coupling the light beam B to the light guiding plate 120. A ratio of lengths of the planar region PZ and the inclined region LZ may be varied according to the actual requirement and shall not be restricted here.

Further referring to FIG. 1 and FIG. 3B, the top surface TP of the light coupling unit 130 may have a stepwise shape, as shown in FIG. 3B. More specifically, as shown in FIG. 3B, the thickness D2 of the light coupling unit 130 in the direction substantially parallel to the normal vector of the second bottom surface 132 is first maintained and then gradually decreased, and thereafter maintained again and then gradually decreased from the second light incident surface 131 to the second light emitting surface 133. In other words, the planar region PZ and the inclined region LZ of the top surface TP are alternately arranged to form the stepwise top surface TP, and the top surface TP is still capable of reflecting or totally reflecting the light beam B emitted from the light emitting unit 110 and properly coupling the light beam B to the light guiding plate 120. Thus, the light coupling unit 130 of FIG. 3B and the light coupling unit 130 of FIG. 1 and FIG. 3A achieve similar efficiency. In addition, the top surface TP may be a concave surface that is recessed toward the second bottom surface 132, a convex surface that protrudes in a direction away from the second bottom surface 132, or a wave-shaped curved surface, which all achieve efficiency similar to FIG. 3A and FIG. 3B; however, the disclosure is not limited to the above.

Referring to FIG. 1, FIG. 3C, and FIG. 3D again, FIG. 3C and FIG. 3D illustrate that the light emitting units 110 and the light coupling units 130 are respectively disposed on two first light incident surfaces 123 at two opposite sides of the light guiding plate 120. Because light is transmitted in the light guiding plate 120 and exits via the first light emitting surface 121, the intensity of the light decreases as being transmitted in the light guiding plate 120. The reduction of the intensity of the light transmitted in the light guiding plate 120 is improved by disposing the light emitting units 110 and the light coupling units 130 respectively on the two first light incident surfaces 123 at two opposite sides of the light guiding plate 120, such that light emitting uniformity is enhanced.

Referring to FIG. 1 and FIG. 3A to FIG. 3E, in this embodiment, the second light emitting surface 133 of the light coupling unit 130 includes a first sub light emitting surface 133a and a second sub light emitting surface 133b. The first sub light emitting surface 133a covers a portion of the first light emitting surface 121 and is substantially parallel to and in contact with the first light emitting surface 121. The second sub light emitting surface 133b is substantially parallel to and in contact with the first light incident surface 123. For example, as shown in FIG. 3E, a portion of the light that enters the light coupling unit 130 through the second light incident surface 131 may exit through the first sub light emitting surface 133a and then enter the light guiding plate 120 through the first light emitting surface 121 or exit through the second sub light emitting surface 133b and then enter the light guiding plate 120 through the first light incident surface 123. Herein, the first light incident surface 123 and the second light emitting surface 133 have equal widths and heights, such that efficiency similar to FIG. 1 and FIG. 3A to FIG. 3D is achieved.

Further to the above, referring to FIG. 3F again, in this embodiment, the second light emitting surface 133 of the light coupling unit 130 and the second bottom surface 132 may form an included angle ψ. The first light incident surface 123 of the light guiding plate 120 is substantially parallel to the second light emitting surface 133 of the light coupling unit 130, and the included angle ψ satisfies: 110≦ψ≦160. For example, the second light emitting surface 133 and the second bottom surface 132 of the light coupling unit 130 are as shown in FIG. 3F, and the second light emitting surface 133 and the first light incident surface 123 are substantially parallel to each other and have corresponding widths and heights, such that efficiency similar to FIG. 1 and FIG. 3A to FIG. 3E is achieved.

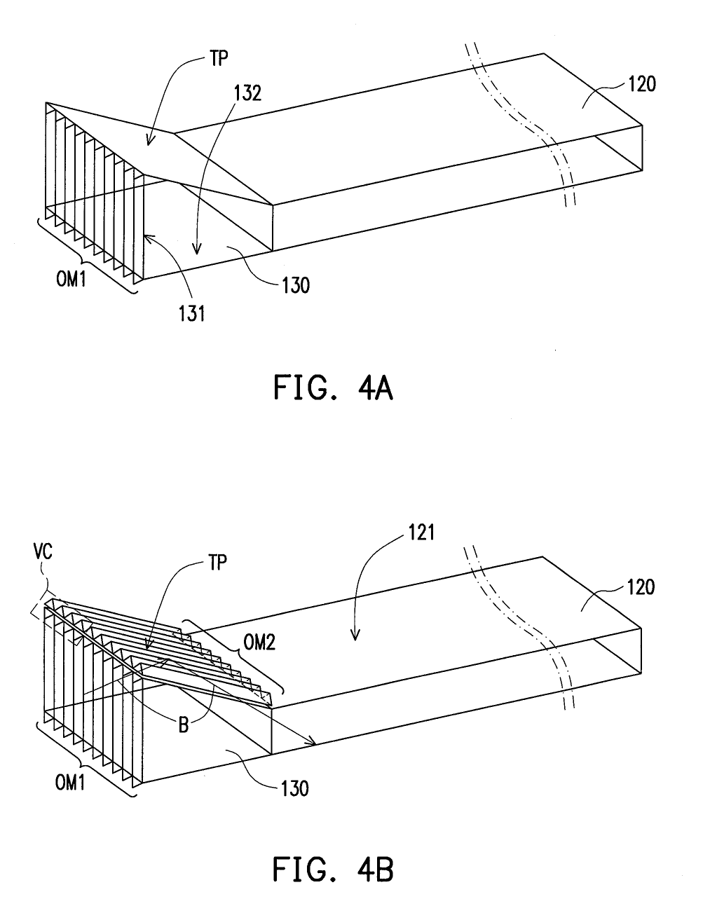

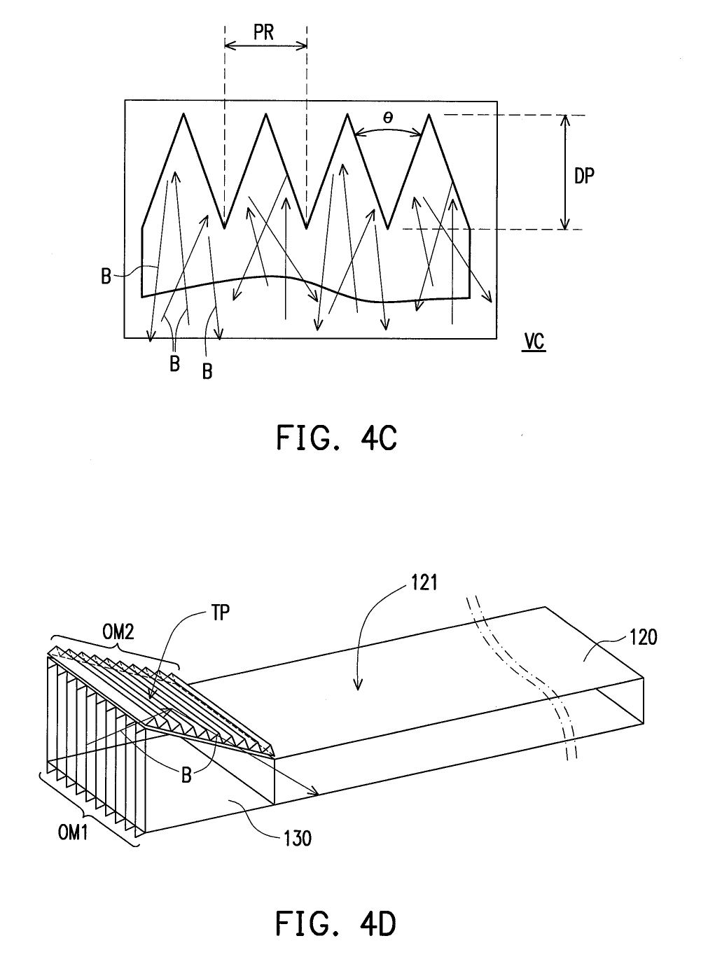

FIG. 4A illustrates an optical micro-structure on the second light incident surface of the light coupling unit in the embodiment of FIG. 1. FIG. 4B illustrates an optical micro-structure on the top surface of the light coupling unit in the embodiment of FIG. 1. FIG. 4C is an enlarged view of a part of the optical micro-structure in FIG. 4B. FIG. 4D illustrates an alteration of the optical micro-structure on the top surface of the light coupling unit in the embodiment of FIG. 1. Referring to FIG. 4A to FIG. 4D, specifically in this embodiment, the light coupling unit 130 may further include a plurality of optical micro-structures OM1 disposed on the second light incident surface 131. The optical micro-structures OM1 are for example triangular prisms (as shown in FIG. 4A) that extend in the direction substantially parallel to the normal vector of the second bottom surface 132. However, in other embodiments, the optical micro-structures OM1 may have other structures (e.g. polygonal prisms, rough surfaces, or trench micro-structures), which shall not be restricted here. The optical micro-structures OM1 diffuse the light that enters the light coupling unit 130 through the second light incident surface 131 uniformly in a direction substantially parallel to the second bottom surface 132, thereby improving the light emitting uniformity of the light guiding plate 120.

In addition, referring to FIG. 4B to FIG. 4D, in this embodiment, the light coupling unit 130 may further include a plurality of optical micro-structures OM2. The optical micro-structures OM2 include a plurality of V-shaped trenches VC, wherein a top angle θ of the V-shaped trench VC is less than or substantially equal to 60 degrees, and a depth DP of the V-shaped trench VC is greater than a distance RR between the top angles of two adjacent V-shaped trenches VC. The optical micro-structures OM2 are arranged on the top surface TP for reflecting or totally reflecting the light that enters the light coupling unit 130. For instance, the optical micro-structures OM2 disposed on the top surface TP change the light emitting conditions of the light beam B at the top surface TP, such that the light beam B that may exit the light coupling unit 130 through the top surface TP due to a large incident angle is reflected or totally reflected into the light guiding plate 120 and the light coupling unit 130, thereby further improving the light coupling efficiency.

The arrangement of the V-shaped trenches VC is as illustrated in FIG. 4B. That is, each of the V-shaped trenches VC extends in a direction substantially perpendicular to a juncture of the top surface TP and the first light emitting surface 121, and the V-shaped trenches VC are arranged in a direction substantially parallel to the juncture. Alternatively, the arrangement of the V-shaped trenches VC is as illustrated in FIG. 4D. That is, each of the V-shaped trenches VC extends in the direction substantially parallel to the juncture of the top surface TP and the first light emitting surface 121, and the V-shaped trenches VC are arranged in the direction substantially perpendicular to the juncture, such that efficiency similar to FIG. 4B is achieved.

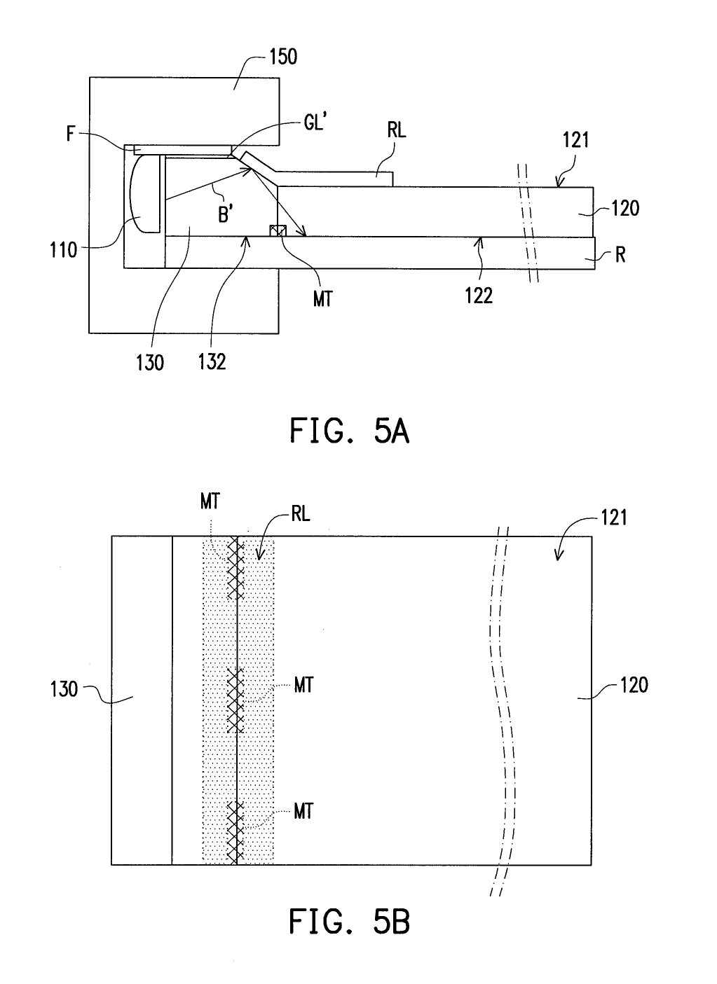

FIG. 5A is a schematic view of a light source module according to another embodiment of the disclosure. FIG. 5B is a schematic top view of a light guiding plate in the embodiment of FIG. 5A. Referring to FIG. 5A and FIG. 5B, this embodiment is similar to the embodiment of FIG. 1, and a difference lies in that: a light source module 100′ of FIG. 5A further includes an outer frame 150 and an adhesive layer GL′. The light emitting unit 110, the light coupling unit 130, and a portion of the reflector R are located in the outer frame 150. The adhesive layer GL′ is disposed between the outer frame 150 and the light coupling unit 130. In this embodiment, the outer frame 150 is for example a lamp cover or a mechanism element having certain structural strength for fixing the light coupling unit 130, the light emitting unit 110, a portion of the light guiding plate 120, and the reflector R, which are adhered and fixed by the adhesive layer GL′. The size of the outer frame 150 may be designed to perfectly receive the components required by the light source module 100′, such as the light coupling unit 130, the light emitting unit 110, etc., so as to stabilize and protect the elements inside the light source module 100′ and further to increase the overall structural strength.

To be more specific, the light source module 100′ may further include a reflective layer RL adhered to a portion of the top surface TP and a portion of the first light emitting surface 121. The reflective layer RL may be a reflective sheet adhered to the portion of the top surface TP and the portion of the first light emitting surface 121 via the adhesive layer, or the reflective layer RL may be high-reflective printing ink, optical reflective coating film, reflective lamp cover, or other mechanism hardware suitable for reflection, for reflecting a light beam B′ emitted from the light emitting unit 110 at a larger angle and keeping the light beam B′ from exiting the light coupling unit 130, so as to further improve the light coupling efficiency. A range covered by the reflective layer RL may vary according to the actual requirement and shall not be restricted here.

More specifically, in addition to the adhesive layer GL, as shown in the embodiment of FIG. 1, the light guiding plate 120 and the light coupling unit 130 may be bonded to each other by at least one welding point MT. In this embodiment, the light guiding plate 120 and the light coupling unit 130 are bonded to each other by a plurality of welding points MT as shown in FIG. 5A and FIG. 5B, wherein the welding points MT may be generated by using laser, ultrasonic wave, etc. In this embodiment, the positions of the welding points MT are between the first bottom surface 122 and the second bottom surface 132. However, in other embodiments, the welding points MT may be located between the first light emitting surface 121 and the top surface TP or at other positions that are suitable for soldering the light guiding plate 120 and the light coupling unit 130. It is noted that the disclosure is not limited thereto.

Moreover, the light source module 100′ may further include a circuit unit F disposed between the outer frame 150 and the light coupling unit 130 and electrically connected to the light emitting unit 110. In this embodiment, the circuit unit F is for example a flexible printed circuit (FPC), but the disclosure is not limited thereto. The circuit unit F, for example, controls the brightness, light emitting frequency, or on/off time, etc., of the light emitting unit 110, such that the application of the light source module 100′ can be more extensive.

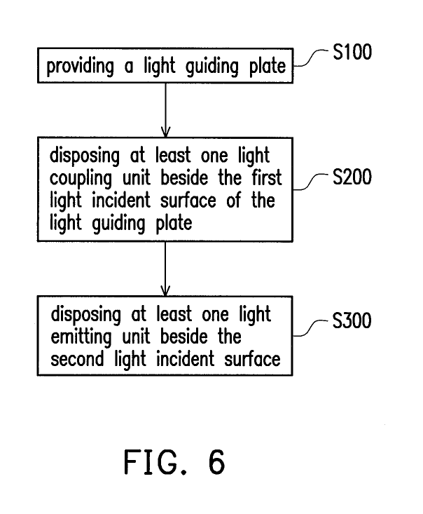

FIG. 6 illustrates a method for manufacturing a light source module according to an embodiment of the disclosure. Referring to FIG. 1 and FIG. 6, the manufacturing method of the light source module 100 includes: providing a light guiding plate 120 (Step S100), which has a first light emitting surface 121, a first bottom surface 122, and at least one first light incident surface 123, wherein the first light emitting surface 121 is opposite to the first bottom surface 122, and the first light incident surface 123 connects the first light emitting surface 121 and the first bottom surface 122. At least one light coupling unit 130 is disposed beside the first light incident surface 123 of the light guiding plate 120 (Step S200), wherein the light coupling unit 130 has a second light incident surface 131 and a second light emitting surface 132. The second light emitting surface 132 of each light coupling unit 130 is in contact with the first light incident surface 123 of the light guiding plate 120. At least one light emitting unit 110 is disposed beside the second light incident surface 131 (Step S300), wherein the number of the light emitting unit 110 is corresponding to the number of the first light incident surface 123 and the number of the light coupling unit 130. For instance, referring to the light source module 100 of FIG. 1, each first light incident surface 123 corresponds to one light coupling unit 130 and one light emitting unit 110. However, the number of the first light incident surface 123, the number of the light coupling unit 130, and the number of the light emitting unit 110 may correspond to each other in other ways and shall not be restricted here. In this embodiment, details and functions of the light source module 100 in the manufacturing method are provided in the descriptions of the embodiments of FIG. 1 to FIG. 4B and thus will be omitted hereinafter. It should be noted that the sequence of the aforementioned Steps S100, S200, and S300 are for illustrative purpose only and shall not be construed as limitations to the disclosure.

More specifically, in this embodiment, a fabricating method of the light guiding plate 120 may include hot extrusion of resin or hot rolling of resin. A fabricating method of the light coupling unit 130 may include mold injection process, extrusion, pressing, or mechanical processing. The light guiding plate 120 and the light coupling unit 130 may be formed of the same or different materials, and the disclosure is not limited thereto. Additionally, when producing light guiding plates with large light emitting areas, it is usually difficult to accurately fabricate thin light guiding plates. And, it is not economical to use mold injection process to fabricate thick light guiding plates. In this embodiment, the aforementioned manufacturing method of the light guiding plate 120 is used to prepare an extruded planar plate of the light guiding plate 120, and then mold injection, extrusion, pressing or mechanical processing is used to fabricate the light coupling unit 130, so as to save production costs, maintain the light emitting quality of the light source module 100, and prevent light leakage at the lateral sides, which may result in decrease of the light guiding efficiency of the light guiding plate, thereby making the production more advantageous. Descriptions of details of the light guiding plate 120 and the light coupling unit 130 and the functions thereof are provided in the embodiments of FIG. 1 to FIG. 4B and thus are not repeated hereinafter.

To be more specific, in this embodiment, the method for manufacturing the light source module may further include disposing a reflector R at a side of the first bottom surface 122 of the light guiding plate 120 and the second bottom surface 132 of the light coupling unit 130. Accordingly, the reflector R reflects the light released through the first bottom surface 122 and the second bottom surface 132 back to the light guiding plate 120 and the light coupling unit 130 to be emitted through the first light emitting surface 121, so as to increase the light emitting efficiency of the light guiding plate 120. In addition, the method for manufacturing the light source module may further include disposing an adhesive layer GL between the reflector R and the light coupling unit 130 and between the reflector R and the light guiding plate 120, such that the light coupling unit 130 and the light guiding plate 120 are fixed on the reflector R by the adhesive layer GL. Details and functions of the light guiding plate 120 and the light coupling unit 130 and configurations and functions of the reflector R and the adhesive layer GL are explained in the embodiments of FIG. 1 to FIG. 4B and thus shall not be repeated hereinafter.

Moreover, the method for manufacturing the light source module may further include: providing an outer frame 150 to receive the light emitting unit 110, the light coupling unit 130, and a portion of the reflector R. Furthermore, an adhesive layer GL′ is disposed between the outer frame 150 and the light coupling unit 130 for the outer frame 150 to fix the light coupling unit 130, the light emitting unit 110, and the reflector R. Herein, the light guiding plate 120 may be connected with the light coupling unit 130 through at least one welding point MT, or connected and fixed to the reflector R through the adhesive layer GL. By disposing the outer frame 150, the structural strength of the fabricated light source module 100′ is enhanced for various applications. Detailed elements and functions of the light source module 100′ are provided in the descriptions of the embodiments of FIG. 1 to FIG. 4B and thus shall not be repeated hereinafter.

To conclude the above, in an embodiment of the disclosure, the light coupling unit is used to properly guide the light emitted from the thicker light emitting unit to the thinner light guiding plate, so as to prevent problems, such as decreasing light emitting efficiency and light leakage, caused by light released at the discrepant lateral sides of the light emitting unit and the light guiding plate. Besides, because the light coupling unit and the light guiding plate may be separately fabricated, production costs are reduced and production efficiency is improved. In addition, the light source module may include the reflector for reflecting the light released from the first bottom surface, and the light coupling unit may include the optical micro-structures on the second light incident surface and the top surface to further improve the light coupling efficiency.

It will be apparent to those skilled in the art that various modifications and variations can be made to the disclosed embodiments without departing from the scope or spirit of the disclosure. In view of the foregoing, it is intended that the disclosure covers modifications and variations of this disclosure provided that they fall within the scope of the following claims and their equivalents.

What is claimed is:

1. A light source module, comprising:
at least one light emitting unit emitting a light beam;
a light guiding plate comprising a first light emitting surface, a first bottom surface, and at least one first light incident surface, wherein the first light emitting surface is opposite to the first bottom surface, and the first light incident surface connects the first light emitting surface and the first bottom surface; and
at least one light coupling unit comprising a second light incident surface and a second light emitting surface, the light emitting unit being disposed beside the second light incident surface, and the light beam entering the light coupling unit through the second light incident surface, exiting the light coupling unit through the second light emitting surface, and entering the light guiding plate through the first light incident surface, wherein the first light incident surface is in contact with the second light emitting surface, and the number of the light emitting unit corresponds to the number of the first light incident surface and the number of the light coupling unit.

2. The light source module according to claim 1, wherein the light coupling unit further comprises a second bottom surface and a top surface opposite to the second bottom surface, the second bottom surface and the first bottom surface are located on the same plane, the second bottom surface connects the second light incident surface and the second light emitting surface, and the top surface connects the second light incident surface and the second light emitting surface, wherein the length of the second light incident surface in a direction substantially parallel to a normal vector of the second bottom surface is greater than the length of the second light emitting surface in the direction substantially parallel to the normal vector of the second bottom surface.

3. The light source module according to claim 2, wherein the thickness of the light coupling unit gradually decreases from the second light incident surface to the second light emitting surface.

4. The light source module according to claim 3, wherein an included angle between the second light emitting surface and the second bottom surface of the light coupling unit is ψ, the first light incident surface of the light guiding plate and the second light emitting surface of the light coupling unit are substantially parallel to each other, and the included angle ψ satisfies: 110≦ψ≦160.

5. The light source module according to claim 3, wherein the second light emitting surface of the light coupling unit comprises a first sub light emitting surface and a second sub light emitting surface, the first sub light emitting surface covers a portion of the first light emitting surface and is substantially parallel to and in contact with the first light emitting surface, and the second sub light emitting surface is substantially parallel to and in contact with the first light incident surface.

6. The light source module according to claim 2, wherein the thickness of the light coupling unit is first maintained and then gradually decreased from the second light incident surface to the second light emitting surface.

7. The light source module according to claim 2, wherein the light coupling unit further comprises a plurality of optical micro-structures arranged on the top surface.

8. The light source module according to claim 7, wherein the optical micro-structures comprise a plurality of V-shaped trenches, wherein a top angle of the V-shaped trenches is less than or substantially equal to 60 degrees, and a depth of the V-shaped trenches is greater than a distance between the top angles of two adjacent V-shaped trenches.

9. The light source module according to claim 8, wherein each of the V-shaped trenches extends in a direction substantially parallel to a juncture of the top surface and the first light emitting surface, and the V-shaped trenches are arranged in a direction substantially perpendicular to the juncture.

10. The light source module according to claim 8, wherein each of the V-shaped trenches extends in the direction substantially perpendicular to the juncture of the top surface and the first light emitting surface, and the V-shaped trenches are arranged in the direction substantially parallel to the juncture.

11. The light source module according to claim 1, further comprising a reflector located under the first bottom surface and the second bottom surface to support the light guiding plate and the light coupling unit.

12. The light source module according to claim 11, further comprising an adhesive layer disposed between the reflector and the light coupling unit and between the reflector and the light guiding plate to fix the light coupling unit and the light guiding plate to the reflector.

13. The light source module according to claim 11, further comprising:
an outer frame receiving the light emitting unit, the light coupling unit, a portion of the light guiding plate, and a portion of the reflector; and
an adhesive layer disposed between the outer frame and the light coupling unit, wherein the outer frame fixes the light coupling unit and the reflector.

14. The light source module according to claim 11, wherein the light guiding plate and the light coupling unit are bonded to each other through at least one welding point.

15. The light source module according to claim 11, further comprising a reflective layer adhered to a portion of the top surface and a portion of the first light emitting surface.

16. The light source module according to claim 11, further comprising a circuit unit disposed between the outer frame and the light coupling unit and electrically connected to the light emitting unit.

17. A manufacturing method of a light source module, comprising:
providing a light guiding plate comprising a first light emitting surface, a first bottom surface, and at least one first light incident surface, wherein the first light emitting surface is opposite to the first bottom surface, and the first light incident surface connects the first light emitting surface and the first bottom surface;
disposing at least one light coupling unit beside the first light incident surface of the light guiding plate, wherein each light coupling unit comprises a second light incident surface and a second light emitting surface, and the second light emitting surface of each light coupling unit is in contact with the first light incident surface of the light guiding plate; and
disposing at least one light emitting unit beside the second light incident surface, wherein the number of the first light incident surface corresponds to the number of the light coupling unit and the number of the light emitting unit.

18. The manufacturing method according to claim 17, wherein a method for fabricating the light guiding plate comprises hot extrusion of resin or hot rolling of resin.

19. The manufacturing method according to claim 17, wherein a method for fabricating the light coupling unit comprises mold injection process.

20. The manufacturing method according to claim 17, further comprising:
disposing a reflector at a side of the first bottom surface of the light guiding plate and the second bottom surface of the light coupling unit.

21. The manufacturing method according to claim 20, further comprising:
disposing an adhesive layer between the reflector and the light coupling unit and between the reflector and the light guiding plate to fix the light coupling unit and the light guiding plate to the reflector.

22. The manufacturing method according to claim 21, further comprising:
providing an outer frame to receive the light emitting unit, the light coupling unit, a portion of the light guiding plate, and a portion of the reflector; and
disposing an adhesive layer between the outer frame and the light coupling unit for the outer frame to fix the light coupling unit and the reflector.
